(19) United States
(12) Patent Application Publication
(10) Pub. No.: US 2021/0245620 A1
(43) Pub. Date: Aug. 12, 2021

(54) VEHICLE CHARGING ACCEPTANCE RATE ADJUSTMENT METHOD AND ADJUSTMENT SYSTEM

(71) Applicant: Ford Global Technologies, LLC, Dearborn, MI (US)

(72) Inventors: Seth Loveall, Dearborn, MI (US); Brendan Diamond, Grosse Pointe, MI (US); Jonathan Hair, Royal Oak, MI (US)

(21) Appl. No.: 16/788,593

(22) Filed: Feb. 12, 2020

(51) Int. Cl. B60L 53/66; B60L 53/51; H02J 7/35; H02J 7/00

(52) U.S. Cl. CPC B60L 53/66; H02J 7/00032; H02J 7/35; B60L 53/51

(57) ABSTRACT

A vehicle charging acceptance rate adjustment method includes, among other things, receiving a communication at an electrified vehicle. The communication includes a local system delivery rate of a local renewable energy system. The method further includes adjusting a vehicle charging acceptance rate based, at least in part, on the local system delivery rate, and charging a traction battery of the electrified vehicle at the vehicle charging acceptance rate.

### TECHNICAL FIELD

This disclosure relates generally to adjusting a vehicle charging acceptance rate of an electrified vehicle based on a local system delivery rate of a local renewable energy system.

### BACKGROUND

Electrified vehicles can include traction batteries that can be recharged. Electrical energy that charges the traction batteries can be provided by a local renewable energy system, an electrical grid, or both.

### SUMMARY

A vehicle charging acceptance rate adjustment method, according to an exemplary aspect of the present disclosure includes, among other things, receiving a communication at an electrified vehicle. The communication includes a local system delivery rate of a local renewable energy system. The method further includes adjusting a vehicle charging acceptance rate based, at least in part, on the local system delivery rate. The method additionally includes charging a traction battery of the electrified vehicle at the vehicle charging acceptance rate.

Another example of the foregoing method includes charging the traction battery with, exclusively, electrical energy generated by the local electrical energy generating system.

In another example of any of the foregoing methods, during the charging, electrical energy generated by the local electrical energy generating system is transferred to the traction battery of the electrified vehicle without storing the electrical energy within a local battery.

In another example of any of the foregoing methods, the local renewable energy system generates electrical energy from a renewable energy source.

In another example of any of the foregoing methods, the renewable energy source is a solar source.

In another example of any of the foregoing methods, the adjusting comprises nominally matching the vehicle charging acceptance rate of the electrified vehicle to the local system delivery rate of the local renewable energy generating system.

In another example of any of the foregoing methods, the adjusting comprises reducing the vehicle charging acceptance rate of the electrified vehicle in response to the local system delivery rate of local electrical energy generating system.

In another example of any of the foregoing methods, the communication received at the electrified vehicle is transmitted to the electrified vehicle from the local renewable energy system.

In another example of any of the foregoing methods, the communication received at the electrified vehicle is transmitted to the electrified vehicle from electric vehicle supply equipment used to charge the traction battery.

In another example of any of the foregoing methods, the communication received at the electrified vehicle is transmitted through a cloud server.

In another example of any of the foregoing methods, the communication received at the electrified vehicle is a wireless communication.

Another example of any the foregoing methods includes additionally adjusting the vehicle charging acceptance rate of the electrified vehicle based on how much electrical energy generated by the local electrical energy source is transferred to local loads other than the electrified vehicle.

In another example of any the foregoing methods, after the adjusting, the vehicle charging acceptance rate during the charging is less than a maximum vehicle charging acceptance rate of the electrified vehicle.

A vehicle charging acceptance rate adjustment method according to another exemplary aspect of the present disclosure includes, among other things, receiving a communication. The communication including a local system delivery rate of a local renewable energy system. The method further includes adjusting a vehicle charging acceptance rate for an electrified vehicle based, at least in part, on the local system delivery rate. The adjusting lowers the vehicle charging acceptance rate to be less than a maximum vehicle charging acceptance rate for the electrified vehicle.

In another example of the foregoing method, the adjusting comprises adjusting a control signal communicated from electric vehicle supply equipment to the electrified vehicle. The method also includes charging a traction battery of the electrified vehicle at the vehicle charging acceptance rate using the electric vehicle supply equipment.

A vehicle charging acceptance rate adjustment system according to another exemplary aspect of the present disclosure includes, among other things, a traction battery of an electrified vehicle. The traction battery is configured to be charged with electrical energy that is generated by a local renewable energy system. The system additionally includes a control module of the electrified vehicle. The control module is configured to adjust a vehicle charging acceptance rate based, at least in part, on a local system delivery rate of the local renewable energy system.

In another example of the foregoing system, the control module is configured to adjust the vehicle charging rate to nominally match the local system delivery rate.

In another example of any of the foregoing systems, the control module is configured to adjust the vehicle charging acceptance rate to be less than a maximum vehicle charging acceptance rate of the vehicle.

In another example of any of the foregoing systems, the local energy system is configured to generate electrical energy from a renewable source.

Another example of any of the foregoing systems includes a wireless receiver of the electrified vehicle. The wireless receiver is configured to receive a communication from outside the electrified vehicle. The communication includes the local system delivery rate.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a charging station, an electrified vehicle, a local renewable energy system, and an electrical grid.

FIG. 2 illustrates a side and partially schematic view of the electrified vehicle of FIG. 2.

FIG. 3 illustrates a flow of an exemplary vehicle charging acceptance rate adjustment method used by the electrified vehicle of FIG. 2.

### DETAILED DESCRIPTION

A local renewable energy system can generate electrical energy from a renewable source, (e.g., solar, wind, hydroelectric). Often, the electrical energy generated by the local renewable energy system is used locally (i.e., without being fed to an electrical grid).

That said, some local renewable energy systems can connect to an electrical grid. This enables the local renewable energy system to feed electrical energy into the electrical grid. Electrical energy generated by the local renewable energy system can be fed into the electrical grid rather than being stored locally within a battery, for example. In exchange for the electrical energy fed into the electrical grid, an owner of the local renewable energy system may be given credits or another type of payment.

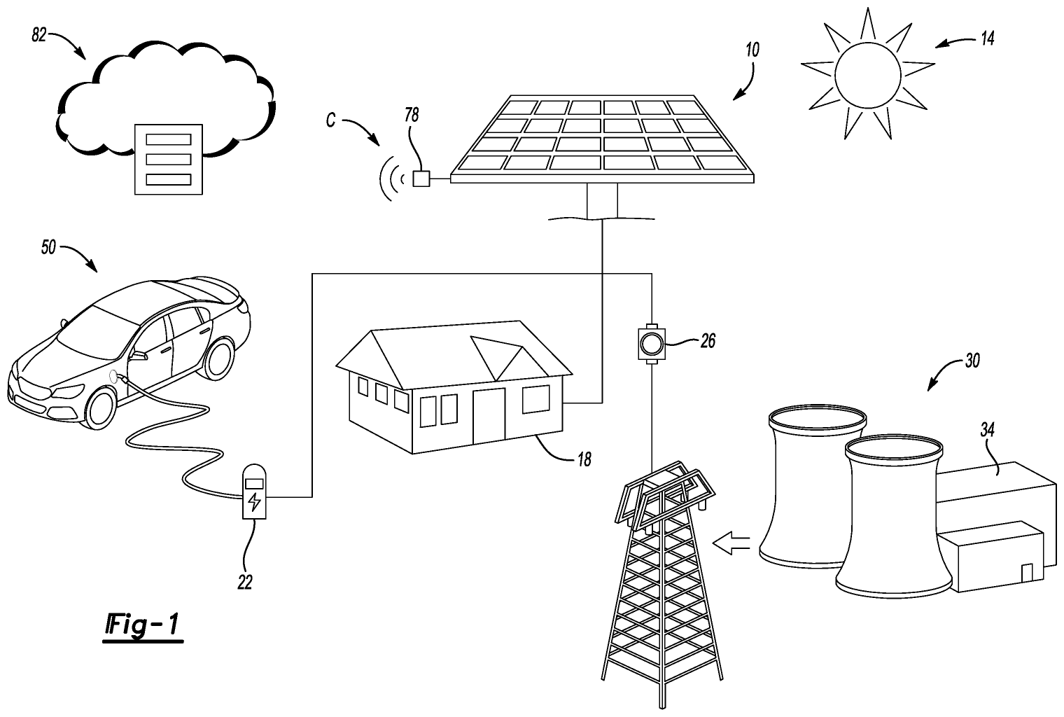

With reference to FIG. 1, a local renewable energy system 10 generates electrical energy. In the exemplary embodiment, the local renewable energy system 10 is a home solar electric system that generates electrical energy from solar energy provided by the sun 14. Electrical energy generated by the local renewable energy system 10 can be used locally to power a home 18, an electrified vehicle charging station 22, or both.

Electrical energy generated by the local renewable energy system 10 can instead, or additionally, be fed through a grid meter 26 to an electrical grid 30, which is an interconnected network for delivering electrical energy to various consumers. If the local renewable energy system 10 is unable to generate sufficient electrical energy to adequately meet the demands of the home 18 or the charging station 22, the electrical grid 30 can provide electrical energy to the home 18 or the charging station 22. The electrical grid 30 is, in some examples, referred to as mains electricity, grid power, or wall power.

In the exemplary embodiment, the electrical grid 30 is operated by a utility company. A plurality of power stations 34 can produce electrical energy for the electrical grid 30. To produce electrical energy, the power stations 34 could include generators driven by heat engines that are fueled by burning fossil fuels, nuclear fission, flowing water, or wind. When driven, the generators produce electrical energy. In some examples, the power stations 34 could instead or additionally generate electrical energy from geothermic or solar sources.

The electrical grid 30 is not a local renewable energy system at least because as the electrical grid 30 relies on power stations 34 that are remote from the home 18, is controlled by the electric utility company, and delivers electrical energy to many consumers. A local renewable energy system can be owned, maintained, and operated by a consumer, whereas an electric utility company can own, maintain, and operate the electrical grid.

Further, the local renewable energy system 10 is separated from the electrical grid 30 by the grid meter 26, which can be considered a boundary between the electric grid 30 and the local renewable energy system 10. A person having skill in this art and the benefit of this disclosure would understand how an electrical grid differs from a local renewable energy system.

Some utility companies that manage the electrical grids have introduced programs that compensate a customer for the electrical energy fed into the electrical grid from a local renewable energy system. The compensation may be a monetary credit or another type of compensation. This exchange means that the residential or commercial customer is effectively selling electrical energy back to the utility company.

For example, a residential or commercial customer that owns a local renewable energy system may receive a billing credit for electrical energy than they feed from their local renewable energy system to the electrical grid. Such compensation programs are sometimes referred to as “net metering” programs. These compensation programs provide a way to compensate an owner of a local renewable energy systems for the electrical energy that they add to the electrical grid.

Typically, the utility company does not provide complete compensation for the electrical energy added to the electrical grid. For example, a utility company may credit a customer 7.5 cents per kWh for energy that the customer's local renewable energy system provides to the electrical grid. The utility company, however, charges the customer 15 cents per kWh for energy that the customer draws from the electrical grid. In such an example, the utility company is effectively providing a 50% credit for each kWh of energy provided to the electrical grid from the local renewable energy system. Given this, the customer may find it economically advantageous to increase their reliance on energy generated by the local renewable energy system 10 thereby decreasing their reliance on energy provided by the electrical grid 30.

For purposes of this disclosure, a rate at which the local renewable energy system 10 can provide electrical energy is referred to as a local system delivery rate. For the local renewable energy system 10, the local system delivery rate can fluctuate based on an available amount of solar energy from the sun 14. The local system delivery rate may, for example, decrease on cloudy days and increase on sunny days. Further, the local system delivery rate may be effectively zero at night and then increase to a peak around midday.

In another example, a local renewable energy system can generate electrical energy from wind power. In such systems, the local system delivery rate could increase and decrease based on windspeed.

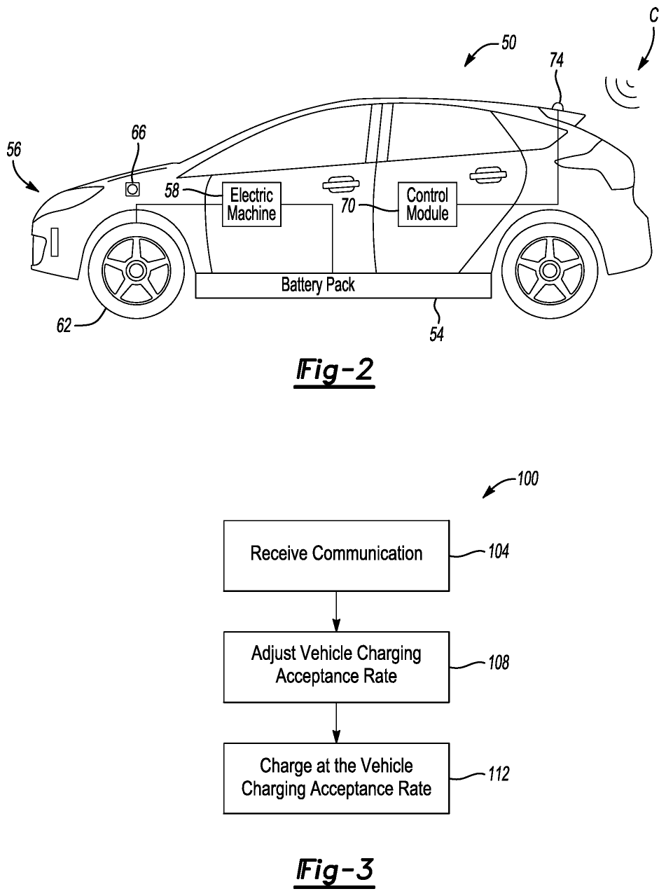

With reference now to FIG. 2 with continuing reference to FIG. 1, an electrified vehicle 50 includes a traction battery 54 and an electric machine 58. Electrical energy from the traction battery 54 can power the electric machine 58, which then drives wheels 62 of the electrified vehicle 50.

In this example, the electrified vehicle 50 is an all-electric vehicle. In other examples, the electrified vehicle 50 could be plug-in hybrid electric vehicle (PHEV), which selectively drives wheels using torque provided by an internal combustion engine instead of or in addition to, torque provided by an electric machine. Generally, the electrified vehicle 50 could be any type of vehicle having a traction battery.

Operating the electric machine 58 depletes an amount of electrical energy stored within the traction battery 54. The electrified vehicle 50 is configured to recharge the traction battery 54 from an external source of electrical energy.

The electrified vehicle 50 includes a charge port 66. Electric Vehicle Supply Equipment (EVSE) associated with the charging station 22 can be electrically coupled to the charge port 66. When electrically coupled, the charging station 22 can supply electrical energy to the traction battery 54 to charge the traction battery 54. The traction battery 54 can be recharged with energy generated by the local renewable energy system 10, which is near the location of the electrified vehicle 50.

For purposes of this disclosure, a rate at which the traction battery 54 of the electrified vehicle 50 can be charged is referred to a vehicle charging acceptance rate. A maximum vehicle charging acceptance rate for a given vehicle can vary based on, among other things, the construction of the traction battery 54, a capacity of the traction battery 54, and other variables. In the exemplary electrified vehicle 50, the vehicle charging acceptance rate is adjustable from 0 to a maximum of 6.6 kW. In another exemplary electrified vehicle, the vehicle charging acceptance rate is adjustable from 0 to a maximum of 10.0 kW.

The electrified vehicle 50 includes a control module 70. The control module 70 is configured to adjust the vehicle charging acceptance rate. The control module 70 can be part of a battery electric control module within the vehicle. The control module 70, in this example, includes a processor operatively linked to a memory portion. The processor is programmed to execute a program stored in the memory portion. The program may be stored in the memory portion as software code. The program stored in the memory portion may include one or more additional or separate programs, each of which includes an ordered list of executable instructions for implementing logical functions.

The processor can be a custom made or commercially available processor, a central processing unit (CPU), an auxiliary processor among several processors associated with the control module, a semiconductor based microprocessor (in the form of a microchip or chip set) or generally any device for executing software instructions. The memory portion can include any one or combination of volatile memory elements and/or nonvolatile memory elements.

The traction battery 54 of electrified vehicle 50 can be charged at the charging station 22 of FIG. 1. As previously described, the charging station 22 can utilize electrical energy provided by the local renewable energy system 10, the electrical grid 30, or both to charge the traction battery 54. While charging the electrified vehicle 50 at its maximum vehicle charging acceptance rate, here 6.6 kW, recharges the traction battery 54 relatively quickly, achieving the maximum vehicle charging acceptance rate may require electrical energy from the electrical grid 30. That is, the local system delivery rate of the local renewable energy system 10 may be less than 6.6 kW.

The control module 70 is configured to adjust the vehicle charging acceptance rate of the electrified vehicle 50. The adjusting is based on, among other things, a local system delivery rate of the local renewable energy system 10. In the exemplary embodiment, rather than rely on electrical energy from the electrical grid 30, the control module 70 of the electrified vehicle 50 is configured to adjust the vehicle charging acceptance rate of the electrified vehicle 50 to nominally match or align with the local system delivery rate of the local renewable energy system 10.

The control module 70 adjusts the vehicle charging acceptance rate through, for example, pulse width modulation and switch transitions, which can alter a current control loop of the electrified vehicle 50. The control module 70 can, in some examples, instead or additionally initiate changes to the charging station 22 to alter the rate at which the charging station 22 provides electrical energy to the electrified vehicle 50 thereby effectively altering the vehicle charging acceptance rate.

In a specific example, the control module 70 is an onboard charger that controls the charge current of the traction battery 54 when being charged. The onboard charger can be an AC to DC power conversion device consisting of, among other things, transformers and semiconductors that takes AC power from outside the electrified vehicle 50, and applies DC power to the traction battery 54 of the electric vehicle 50.

The onboard charger can be programmed with logical functions that determine the appropriate charge current for the traction battery 54. The logical functions can rely on factors such as EVSE maximum current capability, temperature of the traction battery 54, and a state of charge of the traction battery 54. In the exemplary embodiment, other factors used by the onboard charger can include the capability of local renewable energy system 10 to provide power, and the local system deliver rate. The control module can use, among other things, pulse width modulation strategies to control current.

The control module 70 is operably coupled to a wireless receiver 74 of the electrified vehicle 50. The wireless receiver 74 can communicate with the local renewable energy system 10, the home 18, the charging station 22, the grid meter 26, or some combination of these. In another example, the wireless receiver 74 can communicate with a user device, such as a smartphone or personal computer. The control module 70 can rely on the wireless receiver to receive information about the local system delivery rate.

In this example, the wireless receiver 74 can receive a wireless communication C from the local renewable energy system 10. The wireless communication C indicates to the control module 70 the local system delivery rate of the local renewable energy system 10. In response to the communication C, the control module 70 adjusts the vehicle charging acceptance rate of the electrified vehicle 50.

In an example, if the local renewable energy system 10 has a local system delivery rate of 5 kW, the control module 70 adjusts the vehicle charging acceptance rate of the electrified vehicle 50 to 5 kW. Aligning the vehicle charging acceptance rate of the electrified vehicle 50 with the local system delivery rate of the local renewable energy system 10 ensures that effectively all the electrical energy provided by the local renewable energy system 10 is utilized locally. That is, without providing electrical energy generated by the local renewable energy system 10 back to the electrical grid 30. Further, aligning the vehicle charging acceptance rate of the electrified vehicle 50 with the local system delivery rate of the local renewable energy system 10 can help to avoid the need to store electrical energy locally outside the electrified vehicle 50. Electrical energy generated by the local renewable energy system 10 that is not used locally can be stored locally rather than fed to the electrical grid 30. The excess electrical energy can be stored within, for example, a local battery outside the electrified vehicle 50. Providing local storage can increase complexity of the local system and can be expensive. Accordingly, some users may wish to avoid the use of, or reduce the need for, local storage.

The control module 70 can adjust, in an exemplary embodiment, the vehicle charging acceptance rate of the electrified vehicle 50 in real time in response to changes in the local system delivery rate. For example, should clouds cover the sun 14 and reduce the local system delivery rate, the control module 70 receives the communication C indicating that the local system delivery rate has been reduced. In response, the control module 70 reduces the vehicle charging acceptance rate of the electrified vehicle 50. Adjusting the vehicle charging acceptance rate of the electrified vehicle 50 in response to the local system delivery rate helps to reduce or eliminate electrical energy provided by the local renewable energy system 10 to the electrical grid 30. Further, adjusting the vehicle charging acceptance rate of the electrified vehicle 50 in response to the local system delivery rate reduce an amount of energy provided by the electrical grid 30 that is utilized to charge the traction battery 54.

The communication C sent to the vehicle can be a wireless communication, such as Bluetooth or Wi-Fi. In some examples, the communication C is sent from a transmitter 78 of the local renewable energy system 10 to a cloud server 82, which then relays the communication C to the wireless receiver 74 of the electrified vehicle 50.

Although the exemplary embodiment sends the communication from the local renewable energy system 10, the communication C could, as previously described, be communicated from the home 18 or the charging station 22. Further, the communication C could be communicated to the electrified vehicle 50 through the EVSE associated with the charging station 22 and through the charge port 66.

In some examples, a user of the electrified vehicle 50 can communicate a desired vehicle charging acceptance rate to the control module 70. The communication of the desired vehicle charging acceptance rate could be a wireless communication from a personal device. If the desired vehicle charging acceptance rate is higher than the local system delivery rate of the local renewable energy system 10, electrical energy from the electrical grid 30 may be used to supplement the charging in order to achieve the user's desired charge rate. The user may send the desired vehicle charging acceptance rate if the user desires to charge the traction battery 54 quickly, for example.

In some examples, the user may specify that the vehicle charging acceptance rate of the electrified vehicle 50 is maximized until the traction battery 54 reaches a threshold state of charge, say 40%. After the traction battery 54 is charged to the threshold state of charge, the control module 70 can be configured to match the vehicle charging acceptance rate of the electrified vehicle 50 to the local system delivery rate of the local renewable energy system 10. In such an example, the user may further specify or select the threshold state of charge.

Setting the threshold state of charge can ensure that the traction battery 54 is recharged as quickly as possible to the threshold state of charge thereby ensuring that the user of the electrified vehicle 50 can achieve a certain range of travel within the electrified vehicle 50. After the state of charge reaches the threshold state of charge, the traction battery 54 may be charged at a rate less than its maximum vehicle charging acceptance rate to facilitate utilizing more energy generated by the local renewable energy system 10, and to reduce electrical energy supplied by the local renewable energy system 10 back to the electrical grid 30.

The control module 70 can adjust the vehicle charging acceptance rate in response to variables in addition to the local system delivery rate of the local renewable energy system 10. The control module 70 may adjust the vehicle charging acceptance rate of the electrified vehicle based on how much electrical energy generated by the local renewable energy system 10 is being directed to local loads other than the electrified vehicle 50.

For example, over time, different amounts of electrical energy may be required to power loads within the home 18. When the home 18 requires a large amount of electrical energy, the control module 70 may adjust the vehicle charging acceptance rate downward to reduce or eliminate a need for electrical energy from the electrical grid 30 to power loads within the home 18. Load sensors, for example, can sense the electrical energy required by the home 18 and provide this information to the control module 18.

For example, if the local system delivery rate is 8 kW, and the home 18 is using 6 kW, the control module 70 can adjust the local system delivery rate to be 2 kW. As the loads required by the home 18 decrease to say 1 kW, the control module 70 increases the vehicle charging acceptance rate to 7 kW. The control module 70 thus changes the vehicle charging acceptance rate to facilitate utilizing electrical energy provided by the local renewable energy system 10 locally.

With reference to FIG. 3, a flow of an example vehicle charging acceptance rate adjustment method 100 begins at a step 104 where an electrified vehicle receives a communication. The communication includes, among other things, a local system delivery rate of a local renewable energy system. Next, at a step 108, the method 100 adjusts a vehicle charging acceptance rate based on the local system delivery rate. After the adjusting, the method 100 moves to a step 112 where the method 100 charges a traction battery of the electrified vehicle at that vehicle charging acceptance rate.

With reference again to FIGS. 1 and 2, the exemplary embodiment adjusts the vehicle charging acceptance rate based on the communication C received by the electrified vehicle 50 and the adjustments are made by, among other things, the control module 70 within the electrified vehicle 50. Other examples could instead adjust the vehicle charging acceptance rate in response to a control signal sent to the electrified vehicle 50 from, for example, the EVSE associated with the charging station 22. The control signal can be sent according to a signaling protocol, such as protocols within the J1772 standard.

In such an example, the EVSE could adjust the control signal to alter the rate that the EVSE transfers power to the electrified vehicle 50. The adjusting of the control signal can be based, at least in part, on the local system delivery rate. The EVSE can adjust the control signal to effectively throttle the vehicle charging acceptance rate.

In a specific example, the EVSE receives a communication from the local renewable energy system 10 that informs the EVSE of the local system delivery rate. The communication could be a wireless communication, a wired communication, or some combination of these. In response, the EVSE adjusts vehicle charging acceptance rate by altering the control signal that the EVSE sends to the electrified vehicle 50. The control signal, among other things, sets the maximum charge current. If the local renewable energy system 10 has a local system delivery rate of 5 kW, the EVSE can adjusts the control signal such that the vehicle charging acceptance rate is 5 kW. The traction battery 54 is then recharged at 5 kW. This rate is used even though the electrified vehicle 50 could, if the grid source 30 recharge the traction battery 54 at a faster rate.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

What is claimed is:

1. A vehicle charging acceptance rate adjustment method, comprising:
receiving a communication at an electrified vehicle, the communication including a local system delivery rate of a local renewable energy system;
adjusting a vehicle charging acceptance rate based, at least in part, on the local system delivery rate; and
charging a traction battery of the electrified vehicle at the vehicle charging acceptance rate.

2. The method of claim 1, further comprising charging the traction battery with, exclusively, electrical energy generated by the local electrical energy generating system.

3. The method of claim 2, wherein, during the charging, electrical energy generated by the local electrical energy generating system is transferred to the traction battery of the electrified vehicle without storing the electrical energy within a local battery.

4. The method of claim 1, wherein the local renewable energy system generates electrical energy from a renewable energy source.

5. The method of claim 4, wherein the renewable energy source is a solar source.

6. The method of claim 1, wherein the adjusting comprises nominally matching the vehicle charging acceptance rate of the electrified vehicle to the local system delivery rate of the local renewable energy generating system.

7. The method of claim 1, wherein the adjusting comprises reducing the vehicle charging acceptance rate of the electrified vehicle in response to the local system delivery rate of local electrical energy generating system.

8. The method of claim 1, wherein the communication received at the electrified vehicle is transmitted to the electrified vehicle from the local renewable energy system.

9. The method of claim 1, wherein the communication received at the electrified vehicle is transmitted to the electrified vehicle from electric vehicle supply equipment used to charge the traction battery.

10. The method of claim 1, wherein the communication received at the electrified vehicle is transmitted through a cloud server.

11. The method of claim 1, wherein the communication received at the electrified vehicle is a wireless communication.

12. The method of claim 1, further comprising additionally adjusting the vehicle charging acceptance rate of the electrified vehicle based on how much electrical energy generated by the local electrical energy source is transferred to local loads other than the electrified vehicle.

13. The method of claim 1, wherein, after the adjusting, the vehicle charging acceptance rate during the charging is less than a maximum vehicle charging acceptance rate of the electrified vehicle.

14. A vehicle charging acceptance rate adjustment method, comprising:
receiving a communication, the communication including a local system delivery rate of a local renewable energy system;
adjusting a vehicle charging acceptance rate for an electrified vehicle based, at least in part, on the local system delivery rate, the adjusting lowering the vehicle charging acceptance rate to be less than a maximum vehicle charging acceptance rate for the electrified vehicle.

15. The vehicle charging acceptance rate adjustment method of claim 14, wherein the adjusting comprises adjusting a control signal communicated from electric vehicle supply equipment to the electrified vehicle, the method further comprising charging a traction battery of the electrified vehicle at the vehicle charging acceptance rate using the electric vehicle supply equipment.

16. A vehicle charging acceptance rate adjustment system, comprising:
a traction battery of an electrified vehicle, the traction battery configured to be charged with electrical energy that is generated by a local renewable energy system; and
a control module of the electrified vehicle, the control module configured to adjust a vehicle charging acceptance rate based, at least in part, on a local system delivery rate of the local renewable energy system.

17. The system of claim 16, wherein the control module is configured to adjust the vehicle charging rate to nominally match the local system delivery rate.

18. The system of claim 16, wherein the control module is configured to adjust the vehicle charging acceptance rate to be less than a maximum vehicle charging acceptance rate of the vehicle.

19. The system of claim 16, wherein the local energy system is configured to generate electrical energy from a renewable source.

20. The system of claim 16, further comprising a wireless receiver of the electrified vehicle, the wireless receiver configured to receive a communication from outside the electrified vehicle, the communication including the local system delivery rate.
